(19) United States
(12) Patent Application Publication
(10) Pub. No.: US 2013/0272677 A1
(43) Pub. Date: Oct. 17, 2013

(54) IMAGE FILE GENERATION DEVICE, IMAGE FILE REPRODUCTION DEVICE, AND IMAGE FILE GENERATION METHOD

(71) Applicant: PANASONIC CORPORATION, Osaka (JP)

(72) Inventors: Kenjiro TSUDA, Kyoto (JP); Yoshiyuki OKIMOTO, Nara (JP); Takayoshi KOYAMA, Osaka (JP); Tatsuro JURI, Osaka (JP)

(21) Appl. No.: 13/912,632

(22) Filed: Jun. 7, 2013

Related U.S. Application Data
(63) Continuation of application No. PCT/JP2012/000245, filed on Jan. 17, 2012.

(30) Foreign Application Priority Data
Jan. 17, 2011 (JP) 2011-006590

(51) Int. Cl. H04N 13/00

(52) U.S. Cl. CPC H04N 13/0055
USPC 386/248

(57) ABSTRACT

An image file generation device includes an image obtaining unit configured to obtain data of a stereoscopic image enabling stereovision, an parallax information obtaining unit configured to obtain parallax information for each of sub-regions (divided regions) of an entire region of the stereoscopic image, and a file generator configured to generate an image file including a data part which stores data of the stereoscopic image obtained by the image obtaining unit and a header part which stores management data for the data of the stereoscopic image stored in the data part. The file generator stores, in the header part, parallax information for each sub-region and information on a method of dividing the region, for each sub-region.

### CROSS-REFERENCE TO RELATED APPLICATIONS

This is a continuation application of International Application No. PCT/JP2012/000245, with an international filing date of Jan. 17, 2012, which claims priority of Japanese Patent Application No.: JP2011-006590 filed on Jan. 17, 2011, the content of which is incorporated herein by reference.

### BACKGROUND

1. Technical Field

The present disclosure relates to an image generation device which can generate stereoscopic image data available for stereovision and an image reproduction device which can display a stereoscopic image.

2. Related Art

Japanese patent application publication JP 2005-73012 A discloses a stereoscopic image recording apparatus which adjusts parallax of a stereoscopic image composed of a plurality of images corresponding to a plurality of viewpoints before recording the stereoscopic image.

In recording a stereoscopic image, the stereoscopic image recording apparatus records adjustment information which is information on parallax adjustment of the stereoscopic image together with the stereoscopic image. The adjustment information is converted into a unit indicating the physical length which is independent of a display and then is recorded.

By using the adjustment information, the stereoscopic image recorded in the stereoscopic image recording apparatus can be subject to parallax amount adjustment, without depending on a size of display, which meets the intention of a user who performed the first parallax adjustment.

### SUMMARY

As described above, the stereoscopic image recording apparatus disclosed in JP 2005-73012 A can record a plurality of images which compose the stereoscopic image as well as adjustment information which is related to parallax adjustment of the stereoscopic image.

However, according to the disclosure of JP 2005-73012 A, information indicting the amount of shift for the entire screen is recorded as the adjustment information, and thus the parallax of the entire screen is adjusted without regard of the composition of the scene or the layout of the subjects, so that a problem occurs in that the stereoscopic image cannot be reproduced according to the user's intention.

An object of the present disclosure is to provide an image file generation device which enables parallax adjustment according to the composition of the scene and the layout of the subjects and an image file reproduction device which enables reproduction of a stereoscopic image according to a user's intention.

In a first aspect of the present disclosure, an image file generation device is provided. The image file generation device includes an image obtaining unit configured to obtain data of a stereoscopic image enabling stereovision, an parallax information obtaining unit configured to obtain parallax information for each of a plurality of sub-regions which are obtained by dividing an entire region of the stereoscopic image into the sub-regions, and a file generator configured to generate an image file including a data part which stores data of the stereoscopic image obtained by the image obtaining unit and a header part which stores management data related to the data of the stereoscopic image stored in the data part. The file generator stores, in the header part, parallax information for each sub-region, and information on a method of dividing the region for each sub-region.

In a second aspect of the present disclosure, an image file reproduction device is provided, which can reproduce stereoscopic image data enabling stereovision. The image file reproduction device includes a file reading unit configured to read out an image file from a recording medium for storing an image file including stereoscopic image data enabling stereovision, an analyzer configured to analyze the image file, and a storage unit which stores parallax information defining a depth of an object in a direction perpendicular to a display screen on which a stereoscopic image is displayed. The image file includes a data part which stores stereoscopic image data and a header part which stores management data for the stereoscopic image data stored in the data part. The header part of the image file stores parallax information for each of a plurality of sub-regions which are obtained by dividing an entire region of the stereoscopic image is into the sub-regions and information on a method of dividing the region into the sub-regions. The analyzer reads out the information on the dividing method and the parallax information for each sub-region from the header part, and stores the read parallax information in the storage area of the storage unit which is secured based on the read information on the dividing method.

In a third aspect of the present disclosure, a method of generating an image file is provided. The method includes obtaining data of a stereoscopic image enabling stereovision, obtaining parallax information, for each of a plurality of sub-regions which are obtained by dividing an entire region of the stereoscopic image into the sub-regions, the parallax information defining a depth of an object in a direction perpendicular to a display screen on which the stereoscopic image is displayed, generating an image file including a data part which stores data of the obtained stereoscopic image and a header part which stores management data for the data of the stereoscopic image stored in the data part. The parallax information for each sub-region and information on a method of dividing the region are stored in the header part.

According to the image file generation device of the present disclosure, during a reproduction of an image file in a reproduction device, parallax information can be obtained for each of predetermined partial regions of an image only by analyzing the header part of the image file. That enables parallax adjustment for each region of an image, therefore, enables the parallax adjustment according to the composition of the scene and the layout of the subjects and enables reproduction of a stereoscopic image according to a user's intention.

### BRIEF DESCRIPTION OF DRAWINGS

FIG. 1 is a block diagram of an image file generation device of the present embodiment;

FIGS. 2A to 2D are diagrams describing division of an image region;

FIG. 3A is a diagram illustrating a parallax by which a subject appears to be in front of a screen, and FIG. 3B is a diagram illustrating a parallax by which a subject appears to be behind the screen;

FIG. 4 is a diagram for describing information indicating a region containing a main subject in the present embodiment;

FIGS. 5A and 5B are diagrams for describing parallax conditions;

FIG. 6 is a diagram describing a data structure of an image file generated in the present embodiment;

FIG. 7 is a diagram describing a data structure of management information for a stereoscopic image generated in the present embodiment;

FIG. 7A is a diagram describing an example of the data structure of management information for a stereoscopic image which contains information indicating determination result on the main subject;

FIG. 7B is a diagram describing another example of the data structure of management information for a stereoscopic image which contains information indicating determination result on the main subject; and

FIG. 8 is a block diagram of an image file reproduction device of the present embodiment.

### DETAILED DESCRIPTION OF PREFERRED EMBODIMENTS

Embodiments are described below in detail suitably with reference to the drawings.

### 1. An Image File Generation Device

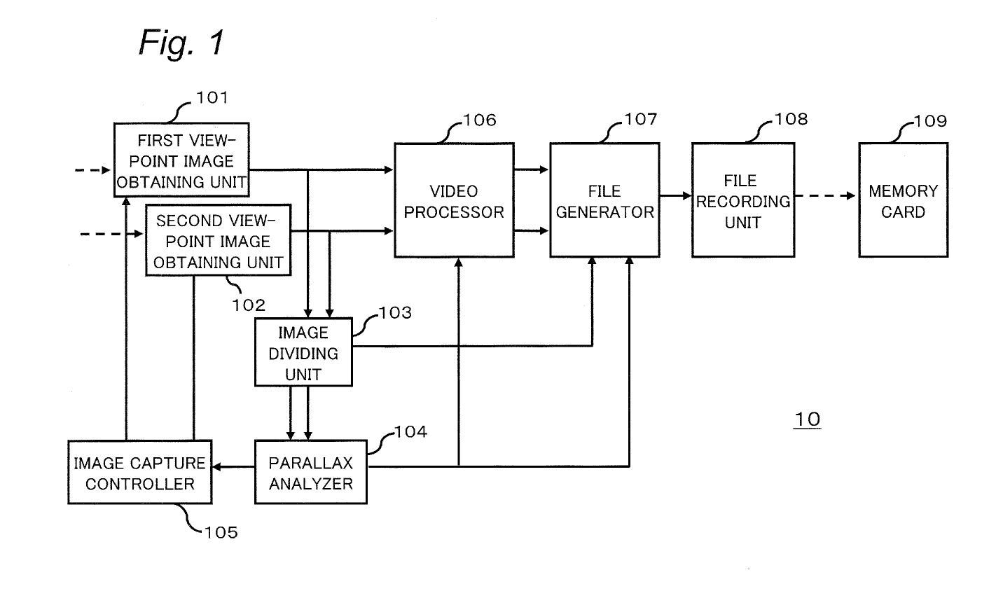

FIG. 1 is a diagram illustrating a configuration of the image file generation device of the present embodiment. As an image file generation device 10, a digital camera, a digital movie camera, or the like which can generate a stereoscopic image are assumed. In short, the image file generation device 10 may be any device as far as it can generate a plurality of images which compose a stereoscopic image. In the present embodiment, it is assumed that a stereoscopic image is composed of two images (a first viewpoint image and a second viewpoint image) which are captured from different two viewpoints (a first viewpoint and a second viewpoint).

As illustrated in FIG. 1, the image file generation device 10 includes a first viewpoint image obtaining unit 101, a second viewpoint image obtaining unit 102, an image dividing unit 103, a parallax analyzer 104, an image capture controller 105, a video processor 106, a file generator 107, and a file recording unit 108.

The first viewpoint image obtaining unit 101 sets shooting parameters related to zoom (change of focal distance), focus, aperture, image stabilization, and the like, under the control of the image capture controller 105. Then, the first viewpoint image obtaining unit 101 generates an image at a first viewpoint (hereinafter, referred to as “the first viewpoint image”) based on the set shooting parameters. The generated first viewpoint image is output to the image dividing unit 103 and the video processor 106.

The second viewpoint image obtaining unit 102 sets shooting parameters related to zoom (change of focal distance), focus, aperture, image stabilization, and the like, under the control of the image capture controller 105. In that case, for example, the second viewpoint image obtaining unit 102 may set the same shooting parameters as those set by the first viewpoint image obtaining unit 101. Then, the second viewpoint image obtaining unit 102 generates an image at a second viewpoint (hereinafter, referred to as “the second viewpoint image”) which is different from the first viewpoint based on the set shooting parameters. The generated second viewpoint image is output to the image dividing unit 103 and the video processor 106.

The first viewpoint image obtaining unit 101 and the second viewpoint image obtaining unit 102 can change a distance (stereo base) between the viewpoint of the first viewpoint image obtaining unit 101 and the viewpoint of the second viewpoint image obtaining unit 102 based on a control signal from the image capture controller 105. Also, the first viewpoint image obtaining unit 101 and the second viewpoint image obtaining unit 102 can change an angle of convergence formed by optical axes of the first viewpoint image obtaining unit 101 and the second viewpoint image obtaining unit 102 based on a control signal from the image capture controller 105.

The image dividing unit 103 logically divides either one of the first viewpoint image and the second viewpoint image which are input from the first viewpoint image obtaining unit 101 and the second viewpoint image obtaining unit 102 into a plurality of regions. For example, the image dividing unit 103 divides an image which is used as a base image (the first viewpoint image or the second viewpoint image) for determining the parallax information by the parallax analyzer 104 into a plurality of sub-regions.

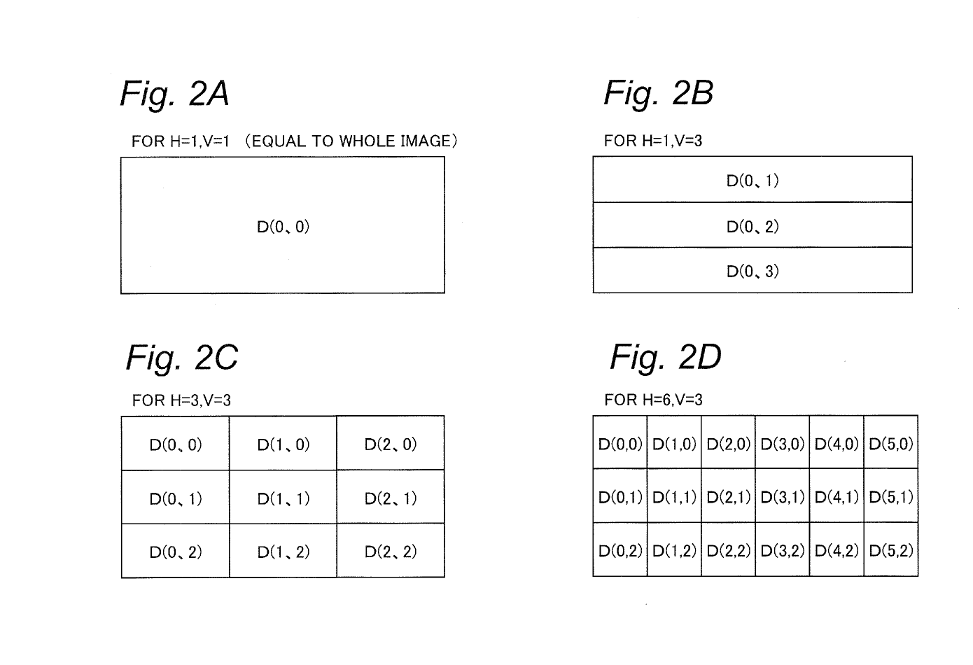

For example, the image dividing unit 103 logically divides an image into sub-regions of n row(s)×m column(s) (here, n and m are positive integers) such as 1 row×3 columns, 3 rows×1 column, or 3 rows×6 columns. FIGS. 2A to 2D are diagrams describing an image division. In FIGS. 2A to 2D, “H” indicates the number of divisions in the horizontal direction and “V” indicates the number of divisions in the vertical direction. D(x, y) indicates the parallax information in the sub-region indicated by x and y. The components x and y are a horizontal coordinate and a vertical coordinate representing the position of each region, respectively. Although the horizontal coordinate and the vertical coordinate are set in the raster scan order, the order is not limited to the raster scan order and may be another order as far as it can identify each region. FIG. 2A indicates the case where an image is divided into 1 row×1 column (H=1, V=1), FIG. 2B indicates the case where an image is divided into 3 rows×1 column (H=1, V=3), FIG. 2C indicates the case where an image is divided into 3 rows×3 columns (H=3, V=3), and FIG. 2D indicates the case where an image is divided into 3 rows×6 columns (H=6, V=3).

The image dividing unit 103 outputs information on the number of divisions of the image region to the parallax analyzer 104 and the file generator 107. Here, the information on the number of divisions of the region may be any information as far as the image dividing unit 103 can recognize the number of divided regions. For example, the information on the number of divisions of the region may be information including the number (H) of horizontal divisions and the number (V) of vertical divisions. For example, when the entire image is divided into 3 rows×1 column, the image dividing unit 103 may output information indicating H=3, V=1.

Further, the image dividing unit 103 outputs two images respectively obtained from the first viewpoint image obtaining unit 101 and the second viewpoint image obtaining unit 102 to the parallax analyzer 104.

The parallax analyzer 104 analyzes the two images received from the image dividing unit 103, obtains the parallax information, dividing unit and outputs the parallax information to the video processor 106 and the file generator 107. Here, the parallax analyzer 104 obtains the parallax information based on the information on the number of divisions of the region received from the image dividing unit 103.

### 1. 1 Parallax Information

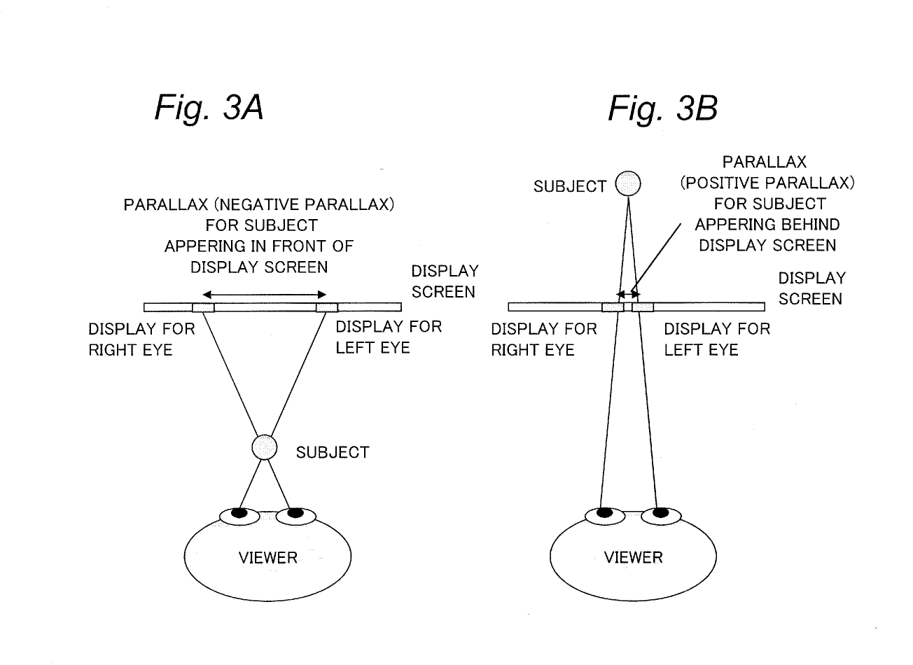

FIGS. 3A and 3B are diagrams illustrating parallax information when a subject appears to be in front of a display screen and when a subject appears to be behind the display screen, respectively. FIG. 3A illustrates the case where the subject appears (is viewed) in front of a display screen, and FIG. 3B illustrates the case where the subject appears behind the display screen. As illustrated in FIGS. 3A and 3B, the display positions of the subject in the horizontal direction in the first viewpoint image and the second viewpoint image differ in the case where the subject appears in front of a display screen and in the case where the subject appears behind the display screen. The information indicating the amount of a difference (deviation) of the appearing position of the subject is referred to as the parallax information. The parallax information is represented by, for example, pixel count or a value of the pixel count divided by the width of the display screen. Meanwhile, the parallax information is not limited to the above described values and any index may be used for the parallax information as far as it can specify the difference.

The parallax analyzer 104 obtains the parallax information for each of predetermined regions of the image based on the two images obtained from the image dividing unit 103. For example, when the information on the number of divisions of the region obtained from the image dividing unit 103 indicates H=3, V=1 (1 row×3 columns), the parallax analyzer 104 obtains three pieces of parallax information in total. Similarly, when the information on the number of divisions of the region indicates H=3, V=6 (6 row×3 columns), the parallax analyzer 104 obtains eighteen pieces of parallax information in total.

In order to obtain the parallax information for each sub-region, the parallax analyzer 104 further divides one sub-region into a plurality of unit regions, then, obtains the amount of parallax for each of the unit regions, and obtains the parallax information of one sub-region based on the amount of parallax obtained for each unit region. Here, the unit region may be a unit including only one pixel (by unit of a pixel) or may be a unit including a plurality of pixels. Alternatively, another unit related to the length other than the pixel may be used. That is, the parallax analyzer 104 may use any unit as far as the unit can represent the deviation in the horizontal direction between the first viewpoint image and the second viewpoint image.

The parallax analyzer 104 obtains, for example, one piece of parallax information which represents each of sub-regions, as the parallax information in each sub-region. The parallax information which represents a sub-region is, for example, information such as the average or the median value of the parallax information. Alternatively, two kinds of parallax information can be obtained in each sub-region, such as the maximum negative parallax which causes the subject to appear in front of the display screen and the maximum positive parallax which causes the subject to appear behind the display screen.

In the case where a piece of parallax information which represents each divided region is obtained, the number of the pieces of information contained in the parallax information D(x, y) of each region is 1, in the example shown in FIGS. 2A to 2D. In the case where two kinds of parallaxes are obtained in each region, such as the maximum negative parallax for causing the subject to appear in front of the screen and the maximum positive parallax for causing the subject to appear behind the screen, the number of the pieces of information contained in the parallax information D(x, y) is 2.

Alternatively, the parallax analyzer 104 may separately obtain a piece of the parallax information corresponding to the infinite direction as the parallax information for the entire image and only the maximum negative parallax as the parallax information for each region. That is, the parallax information corresponding to the infinite direction needs not to be obtained for each sub-region, and only a piece of the parallax information may be obtained for the entire image. In that case, the number of the pieces of information contained in the parallax information D(x, y) is 1.

Further, the parallax analyzer 104 may obtain information on distribution of the amounts of parallax in the divided region. For example, when the information on the number of divisions of the region obtained from the image dividing unit 103 contains H=3, V=1, the parallax analyzer 104 obtains the amount of parallax which represents each of the three sub-regions. Further, the parallax analyzer 104 obtains information on distribution of the amounts of parallax in each of the three sub-regions. In that case, the amount of parallax which represents each sub-region and information on distribution of the amounts of parallax are obtained in association with each other. Here, the information on distribution of the amounts of parallax is a value indicating dispersion of the amounts of parallax in the sub-region, however, it may be any other information indicating distribution.

Further, the parallax analyzer 104 may calculate reliability of the parallax information for each sub-region based on the parallax information obtained for the entire image. In that case, the parallax analyzer 104 outputs the calculated reliability of the parallax information to the file generator 107. The output of the reliability of the parallax information is configured to make it possible to perceive the correspondence between the calculated reliability of the parallax information and the sub-region associated with the reliability. When the parallax information is calculated from the parallax vector by block matching, the matching cost which is calculated based on a predetermined cost function may be used as the reliability of the parallax information. That matching cost is a value which is calculated in the process of obtaining the parallax information. It is possible to use a system to determine that the matching accuracy is high and the reliability is high when the matching cost is smaller than a predetermined value, and to determine that the reliability is low when the matching cost is bigger than the predetermined value. Here, the determination of the reliability of the parallax information is not limited to the determination based on the matching cost as far as it is the information representing the likelihood of the parallax information. For example, information indicating flatness may also be used as the information representing the reliability.

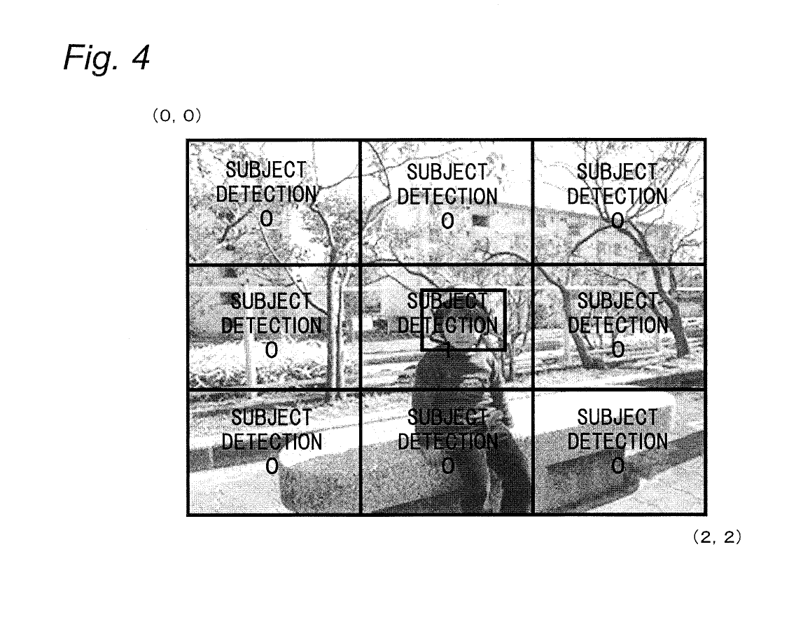

Further, the parallax analyzer 104 may have a function of determining whether the sub-region contains the main subject (subject of interest) or not based on the image data. The determination of a region containing the main subject may be made by determining that a region in which a face is detected is a region which contains the main subject. Alternatively, the main subject maybe detected in a method other than the face detection. The parallax analyzer 104 outputs information indicating the determination result on whether a region contains the main subject or not to the file generator 107. The information indicating the determination result is output in a format which makes it possible to determine which part of the sub-region in the entire image is associated with the calculated determination result. FIG. 4 is a diagram describing the sub-regions which contain the main subject. FIG. 4 indicates the case where the entire image is divided into nine regions as H=3, V=3 and the main subject (person's face) is contained in the sub-region of the coordinates (1, 1).

Further, the parallax analyzer 104 may have an ideal parallax condition set in advance and have a function of determining whether the obtained parallax information satisfies the parallax condition or not. In that case, the parallax analyzer 104 determines whether the parallax condition is satisfied or not for each sub-region. The parallax analyzer 104 outputs the determination result to the file generator 107. The determination result is indicated by, for example, one bit. For example, the determination result is set at “1” in the case where the parallax information satisfies the parallax condition, and is set at “0” in the case where the parallax information does not satisfy the parallax condition. However, the determination result is not limited to one bit value, and may be indicated by any value as far as the value can identify the determination result on the parallax condition.

Further, when the parallax information does not satisfy the parallax condition as a result of the above described determination, the parallax analyzer 104 calculates shooting parameters to satisfy the parallax condition and outputs the calculated shooting parameters to the image capture controller 105. The shooting parameters are parameters which influence the degree of depth of the stereoscopic effect when the first viewpoint image and the second viewpoint image are viewed as the stereoscopic image, such as information including the angle of convergence, the stereo base, the angle of view, or the zoom. The parallax analyzer 104 may output the calculated shooting parameters to the video processor 106.

### 1. 2 Shooting Condition

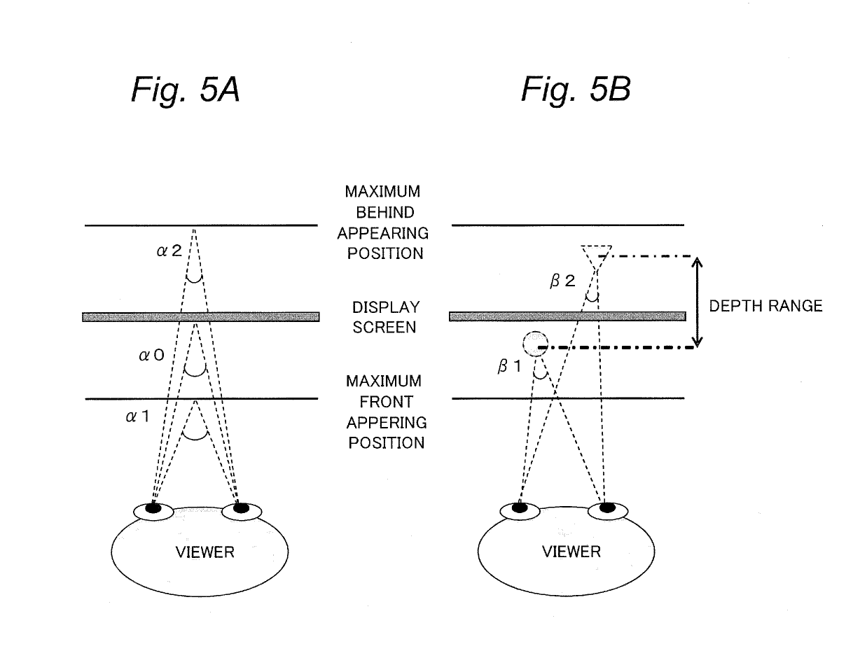

The previously set shooting conditions will be described with reference to the drawing. FIGS. 5A and 5B are diagrams for describing the parallax conditions. As illustrated in FIG. 5A, the parallax analyzer 104 sets the parallactic angle of the position at which the parallax is approximately 0, i.e., the position on the display screen, at α0 based on the image information of the first viewpoint image and the second viewpoint image. Further, the parallax analyzer 104 sets the maximum parallactic angle for the subject which appears in front of the display screen at α1, and sets the minimum parallactic angle for the subject which appears behind the screen at α2. Based on the fact that the image can be easily viewed when the difference between α0 and α1 and the difference between α0 and α2 are within a predetermined range (for example, ±1°), the parallax analyzer 104 sets the parallax condition as α1−α0<1°, α0−α2<1°. The parallax conditions may be decided by taking account of the conditions for easy stereoscopic vision, the conditions for easily obtaining the stereoscopic effect, safety, image quality, and the like.

Further, the parallax analyzer 104 sets the parallactic angle β1 for the subject which appears in front of and farthest from the screen and the parallactic angle β2 for the subject which appears behind and farthest from the screen as illustrated in FIG. 5B. Based on the fact that the image can be easily viewed when the depth range (β1−β2) is within a predetermined range (for example, 1°), the parallax analyzer 104 may set the parallax condition as β1−β2<1°. Alternatively, a condition that the maximum parallax for causing the subject to appear behind and farthest from the screen is not more than the human interocular distance in terms of the amount of deviation on the screen (for example, 50 mm for a child) may be assumed. These conditions may be combined with each other.

The parallax analyzer 104 may be configured to allow the user to input information on an assumed display size to display the image. Further, the parallax analyzer 104 may be configured to set a recommended distance to view the image based on the input information on the assumed display size. The recommended distance is set at, for example, a distance which is three times the vertical size of the assumed display size.

The image capture controller 105 changes, based on the shooting parameters output from the parallax analyzer 104, the shooting parameters such as the zoom (change of the focal distance) of the first viewpoint image obtaining unit 101 and the second viewpoint image obtaining unit 102, the angle of convergence between the two viewpoint image obtaining units 101 and 102, the distance between the two viewpoint image obtaining units 101 and 102, the focus, the aperture, and the image stabilization.

The video processor 106 performs various types of processing on the input two viewpoint images. For example, the video processor 106 performs various video processing such as gamma correction, white balance correction, and flaw correction on the first viewpoint image and the second viewpoint image. Further, the video processor 106 performs image compression in a compression format conforming to the JPEG standard or the like, on the above described processed first viewpoint image and second viewpoint image. The video processor 106 outputs the compressed image to the file generator 107.

When inputting the shooting parameters from the parallax analyzer 104, the video processor 106 performs the parallax adjustment on the two viewpoint images input from the first and second viewpoint image obtaining units 101 and 102. The parallax adjustment refers to a correcting operation for correcting two viewpoint images by signal processing to make the images satisfy the shooting parameters output from the parallax analyzer 104. The correcting operation includes, for example, an operation of trimming the two viewpoint images or an operation of shifting the pixel data. Here, the parallax adjustment is not limited to the above described method, and any method can be used for the parallax adjustment as far as it is a method of changing the stereoscopic effect in viewing the two viewpoint images as the stereoscopic image.

The file generator 107 generates an image file which associates the two viewpoint images output from the video processor 106, the information on the number of divisions of the region output from the image dividing unit 103, and the parallax information obtained for each sub-region output from the parallax analyzer 104. The file generator 107 outputs the generated image file to the file recording unit 108. The above described image file is generated according to the multi-picture format, for example. The file generator 107 can use any file format as far as it can store the two viewpoint images output from the video processor 106 in association with the information on the number of divisions of the region output from the image dividing unit 103 and the parallax information obtained for each sub-region output from the parallax analyzer 104.

The file generator 107 may input a result of predetermined determination processing (determination on the main subject, determination of the parallax condition, or the like) or the shooting parameters from the parallax analyzer 104. When inputting the determination result or the shooting parameters from the parallax analyzer 104, the file generator 107 stores the determination result or the shooting parameters in association with the above described three kinds of information (the two viewpoint images, the information on the number of divisions of the region, the parallax information).

The file recording unit 108 records the image file input from the file generator 107 to a memory card 109. The memory card 109 is a non-volatile memory card such as an SD card, but any recording medium may be used for the memory card 109 as far as it can record the image file generated by the file generator 107.

In the image file generation device 10 of the present embodiment, the parallax analyzer 104, the video processor 106, the image capture controller 105, and the file generator 107 may be implemented as software for a microcomputer or a DSP.

### 1. 3 File Format

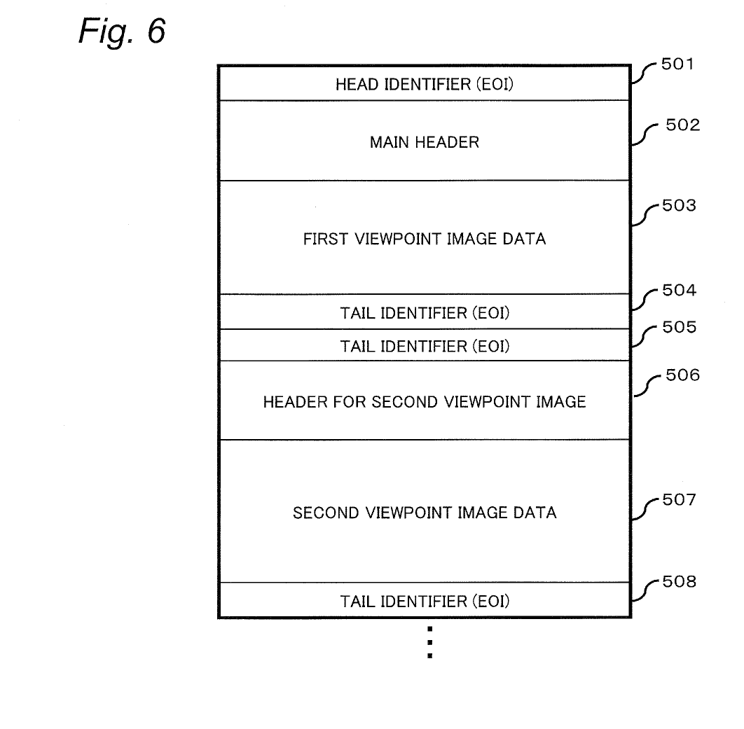

A data structure (file format) of the image file generated by the image file generation device 10 of the present embodiment will be described with reference to FIG. 6. The image file generated by the image file generation device 10 includes a plurality of pieces of image data. In the example of FIG. 6, the image file includes first viewpoint image data and second viewpoint image data. Here, the first viewpoint image data is stored in a data area 503 which is different from a main header part 502 for storing main header information (hereinafter, also simply referred to as “header part”). The second viewpoint image data is stored in the data area 507 which is different from the header part 506 for storing header information for the second viewpoint image. Incidentally, two pieces of image data are stored in an image file in FIG. 6, a plurality of pieces of image data more than two pieces of image data can be stored. That is, a third viewpoint image can be stored in an image file in addition to the first viewpoint image and the second viewpoint image.

A head identifier 501, the main header information 502, the first viewpoint image data 503, and a tail identifier 504 are stored in an image file as a group related to the first viewpoint image.

The head identifier 501 is a marker indicating the starting point of the group storing the first viewpoint image data 503. The head identifier 501 is, for example, start information (xFFJJ8) for a file defined in the JPEG standard.

The main header part 502 stores management data (main header information) of the entire image file. The management data stores information on the stereoscopic effect for viewing the first viewpoint image and the second viewpoint image as the stereoscopic image.

The first viewpoint image data 503 is data compressed in the JPEG format, for example.

The tail identifier 504 is a marker (xFFD9) indicating the end point of the first viewpoint image data 503. With the marker attached to the end of the first viewpoint image data 503, it is not needed to newly add a head identifier (SOI) and a tail identifier (EOI) to files when dividing an image file into two image files containing an image file including the first viewpoint image data 503 and an image file including the second viewpoint image data. Therefore, an image file can be easily divided.

The head identifier 505, the header part 506 for the second viewpoint image, the second viewpoint image data, and the tail identifier 508 are stored in an image file as a group related to the second viewpoint image.

The head identifier 505 is a marker indicating the starting point of the group related to the second viewpoint image data. A table for managing the marker is provided in the main header part 502. The table allows detection of the second viewpoint image data to be easily done. Also, when a file is divided, the dividing point can be easily found. Further, with the marker provided, it is not needed to newly add SOI and EOI to image files when an image file is divided into a plurality of image files. Therefore, a file can be easily divided.

The header information for the second viewpoint image 506 stores attribute information and the like of the second viewpoint image data. The second viewpoint image data is data compressed in the JPEG format.

The tail identifier 508 is a marker indicating the end point of the group related to the second viewpoint image data. A table for managing the marker is provided in the main header part 502. The table allows detection of the second viewpoint image data to be done easily. Also with the table, when a file is divided, the dividing point can be easily found. Further, with the marker provided, it is not needed to newly add SOI and EOI to files when an image file is divided, therefore, a file can be easily divided.

### 1. 3. 1 Management Data Described in Main Header Part

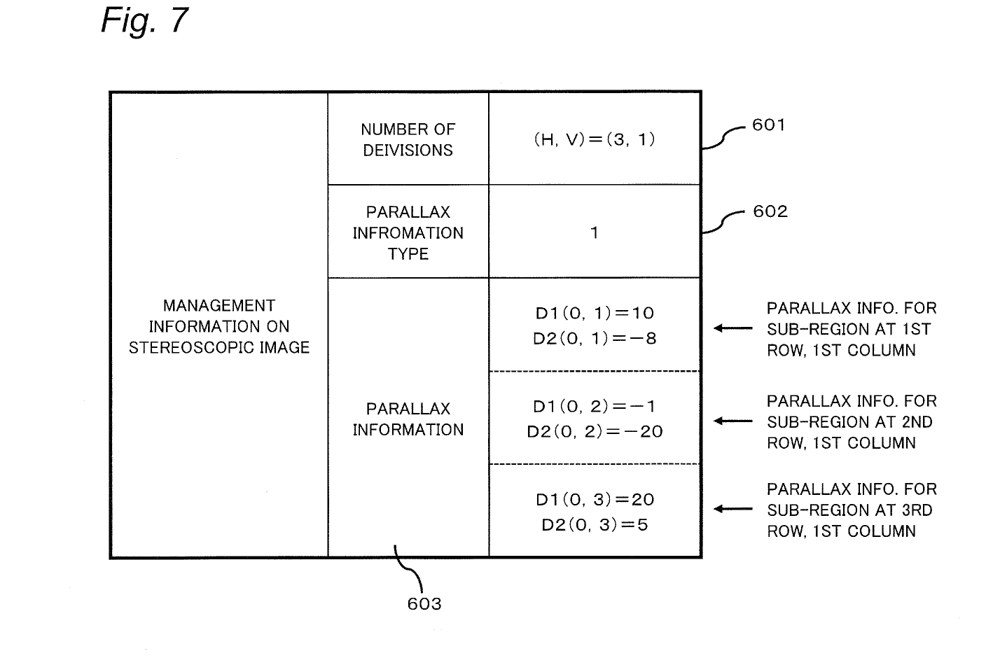

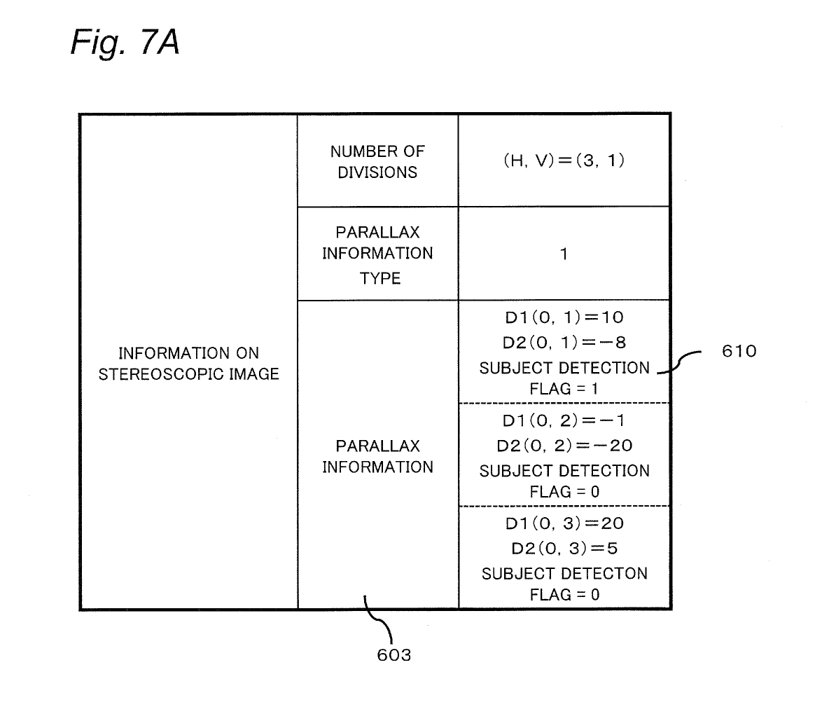

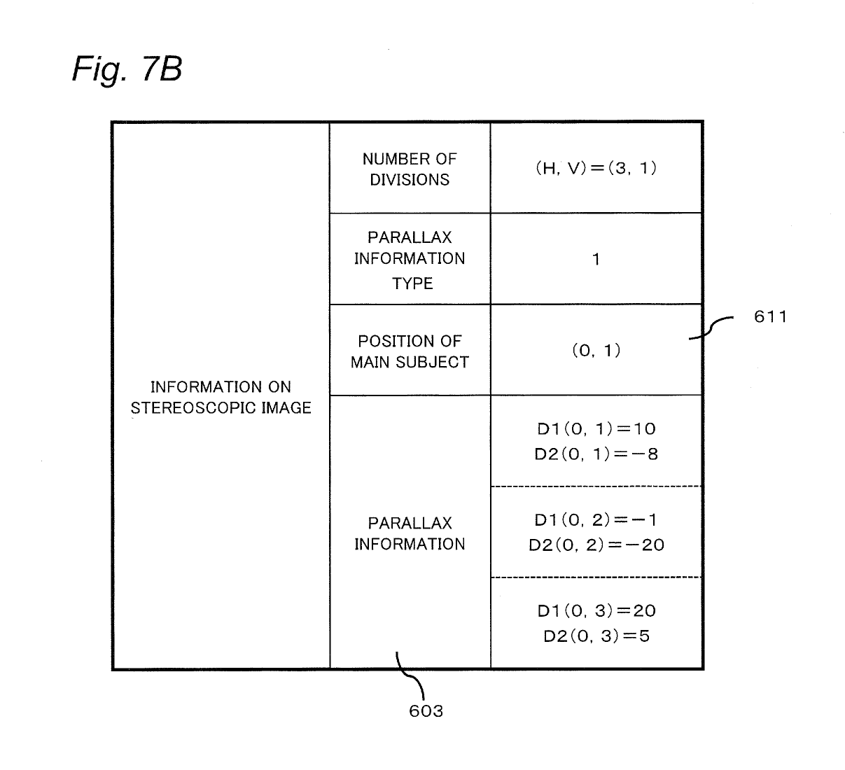

FIG. 7 is a diagram illustrating an exemplary configuration of management data stored in the main header part 502 of the image file. As illustrated in FIG. 7, the management data includes, for example, the number of divisions of the region 601, a parallax information type 602, and the parallax information 603. The management data may be compressed by a predetermined compression scheme.

The number of divisions of the region 601 stores information on a method of dividing an image (here, the number of divisions in the horizontal direction and the vertical direction) output from the image dividing unit 103. The characters H, V in (H, V) shown in FIG. 7 indicate the number of divisions in the horizontal direction and the number of divisions in the vertical direction, respectively. In the case of FIG. 7, it is understood that the parallax information is obtained in a condition that the image is divided into 3 rows and 1 column. Although the number of divisions of the region 601 is represented by one piece of information, it may be represented by two or more pieces of information such as the number of divisions in the horizontal direction H and the number of divisions in the vertical direction V. Instead of the number of divisions of the image, other types of information can be used as far as it can identify the method of dividing the image (for example, a method of dividing the region, the number of divisions).

The parallax information type 602 is information indicating the type of the parallax information obtained by the parallax analyzer 104. As the parallax information type, the types shown below are defined, for example.

Type 1: As the parallax information, two pieces of parallax information are used, including the maximum value of the amount of parallax which causes the subject to appear in front of the display screen (in the first direction which is directed from the display screen toward the viewer), and the maximum value of the amount of parallax which causes the subject to appear behind the display screen (in the second direction which is opposite to the first direction) among the amounts of parallax obtained within the sub-region.

Type 2: As the parallax information, the average of the amounts of parallax obtained within the sub-region is used.

Type 3: As the parallax information, the median value of the amounts of parallax obtained within the sub-region is used.

Type 4: As the parallax information, the maximum value of the amount of parallax which causes the object to appear in front of the display screen, and the parallax value corresponding to the infinite end obtained within the entire image region among the amounts of parallax obtained within the sub-region are used.

Since the parallax information type 602 describes “1” in the example shown in FIG. 7, it is understood that the parallax information is of Type 1. In the case where only a pre-defined type is used, the parallax information type 602 may be omitted.

The parallax information 603 stores the parallax information practically obtained for each sub-region. In the example of FIG. 7, the parallax information of “Type 1” is stored. Therefore, the parallax information 603 stores two amounts of parallax such as the maximum value D1 of the amount of parallax which causes the object to appear in front of the screen and the maximum value D2 of the amount of parallax which causes the object to appear behind the screen, among the amounts of parallax obtained within the sub-region.

When the parallax information cannot be calculated in a certain sub-region in the parallax analyzer 104, the parallax information of the sub-region is set to a predetermined value which indicates that the parallax information cannot be calculated. For example, the predetermined value may be decided in advance between the image file generation device and the image file reproduction device. Further, when the reliability for each sub-region can be obtained from the parallax analyzer 104, the parallax information may be changed according to the reliability. For example, the parallax analyzer 104 may set the parallax information of the sub-region having low reliability to the predetermined value which indicates that the parallax information cannot be calculated.

When the image is two-dimensionally divided into sub-regions, the order of information described in the parallax information 603 is equal to the raster order, for example.

For example, the number of divisions of the region 601 may be placed in the management data so that it can be read before the parallax information 603 when the management data is read. As a result, since the number of divisions of the region 601 can be read out before the parallax information 603, the image file reproduction device can rapidly start the processing based on the number of divisions of the region 601.

The management data stored in the main header part 502 of the image file is not limited to the information illustrated in FIG. 7. Other examples of the management data stored in the main header part 502 of the image file will be described below.

The management data may include, for example, information on a display size which is assumed in determining the parallax condition in the parallax analyzer 104, information on the viewing distance, the maximum parallax condition for the object appearing in front of the display screen, the maximum parallax condition for the object appearing behind the display screen, depth range condition, and human interocular distance parallax condition, in addition to the information illustrated in FIG. 7. The management data may also include the shooting parameters (information including the angle of convergence, the stereo base, the angle of view, the zoom, and the like) obtained from the parallax analyzer 104. The management data may further include the reliability for each sub-region output from the parallax analyzer 104.

The management data may further include the determination result indicating whether the sub-region contains the main subject or not output from the parallax analyzer 104 for each sub-region. For example, as illustrated in FIG. 7A, the management data may store information (flag) 610 indicating the determination result for each sub-region. Alternatively, as illustrated in FIG. 7B, the management data may store information (information identifying the coordinates, the sub-region, or the like) 611 indicating the position of the main subject for the entire image.

The management data may include information indicating the image (the first viewpoint image or the second viewpoint image) which is used as a base for the parallax analyzer 104 to obtain the parallax information. With that configuration, when an image file is reproduced in the reproduction device, the image which is used as a base for obtaining the parallax information stored in the header part 502 can be easily identified only by reading out the above described information.

Further, the header part 502 may further store information on the number of pieces of the parallax information contained in one sub-region. With that configuration, when an image file is reproduced in the reproduction device, the number of pieces of the parallax information recorded for each sub-region can be easily determined only by analyzing the header part 502 of the image file.

Further, the management data may store information on the number of bits (bit precision) of the parallax information obtained for each sub-region. With that configuration, when an image file is reproduced in the reproduction device, the bit precision by which the parallax information is recorded can be determined only by analyzing the header part 502 of the image file.

Further, information on the representative amount of parallax for each sub-region may be stored in the management data. With that configuration, it is enough to store only the information on the representative amount of parallax in the header part 502, reducing the amount of information stored in the header part 502.

Further, the obtained information on the amount of parallax in the infinite direction for the entire stereoscopic image may be stored in the management data, in addition to the information on the representative amount of parallax for each sub-region. With that configuration, it is enough to store only just one piece of infinite direction parallax information in the header part 502 for the entire image, so that the amount of information stored in the header part 502 can be reduced smaller than the case where, for example, the maximum amount of parallax for displaying the subject appearing in front of the display screen and the maximum amount of parallax for displaying the subject appearing behind the display screen are stored for each sub-region.

Further, the representative amount of parallax which represents the amounts of parallax in the sub-region and information indicating the distribution of the amounts of parallax in the sub-region may be stored in the management data for each sub-region. With that configuration, the amount of information stored in the header part 502 can be reduced. In addition, when an image file is reproduced in the reproduction device, various processing such as parallax adjustment can be performed based on the distribution of the amounts of parallax in the sub-region.

Further, parallax information including the information indicating that the parallax information cannot be detected may be stored in the management data. Accordingly, when an image file is reproduced in the reproduction device, it can be easily determined that the parallax information has not been obtained in a particular sub-region by referencing the information indicating that the parallax information cannot be detected.

Further, information indicating the reliability for each sub-region may be stored in the management data. With that configuration, when an image file is reproduced in the reproduction device, processing operations (for example, obtaining of the parallax information again) can be preferably changed for each sub-region according to the reliability corresponding to the parallax information.

### 2. Image File Reproduction Device

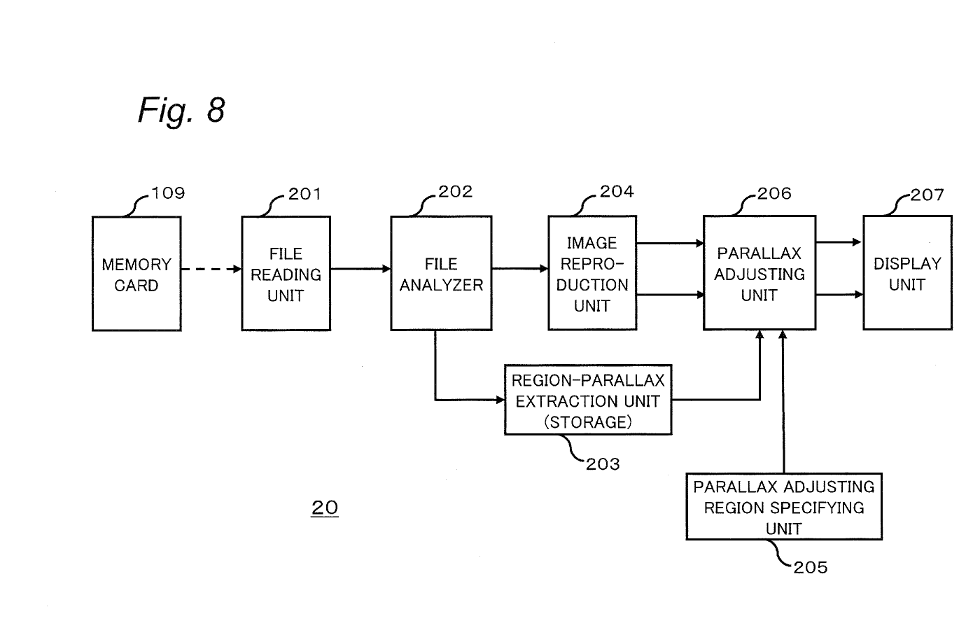

The image file reproduction device which reproduces the image file generated by the above described image file generation device 10 will be described. FIG. 8 is a diagram illustrating a configuration of the image file reproduction device.

The image file reproduction device 20 is a digital television, a system including a digital video player or digital video recorder and a digital television, a system including a digital camera or digital movie camera and a digital television, and the like.

The image file reproduction device 20 includes a file reading unit 201, a file analyzer 202, a region-parallax extraction unit 203, an image reproduction unit 204, a parallax adjusting region specifying unit 205, a parallax adjusting unit 206, and an image display unit 207.

The file reading unit 201 reads out the image file recorded in the memory card 109 and outputs the read out image file to the file analyzer 202.

The file analyzer 202 analyzes the image file obtained from the file reading unit 201. Specifically, the file analyzer 202 extracts the information described in the management data in the main header part 502 of the image file. More specifically, information described in the number of divisions of the region 601, and information described in the parallax type information 602 are extracted. When other information is described, that information is also extracted together with the above described information.

The file analyzer 202 outputs the image data of each viewpoint to the image reproduction unit 204, and outputs the extracted information to the region-parallax extraction unit 203. When the file analyzer 202 analyzes the image file and extracts the shooting parameters or the parallax condition from the header part of the image file, the file analyzer 202 outputs the extracted information to the region-parallax extraction unit 203. When the file analyzer 202 extracts the information on a display size which is assumed in determining the parallax condition in the parallax analyzer 104 of the image file generation device 10, the information on the viewing distance, the maximum parallax condition for displaying the subject appearing in front of the screen, the maximum parallax condition for displaying the subject appearing behind the screen, depth range conditions, the human interocular distance parallax conditions, and the like, the file analyzer 202 outputs them to the parallax adjusting determination unit 203.

The region-parallax extraction unit 203 secures a storage area (storage capacity) for storing the information described in the parallax information 603 analyzer 202 based on the parallax information 603 received from the file analyzer 202. When the data size of each sub-region can be obtained from the file analyzer 202, the region-parallax extraction unit 203 secures the storage area (storage capacity) for storing the information described in the parallax information 603 based on the data size for each of the sub-regions and the information described in the number of divisions of the region 601.

When the region-parallax extraction unit 203 secures the storage area, it reads the information described in the parallax information 603. The region-parallax extraction unit 203 outputs the read information to the parallax adjusting unit 206. Also, the region-parallax extraction unit 203 outputs the information obtained from the file analyzer 202 together with the read information to the parallax adjusting unit 206.

The image reproduction unit 204 converts the image data of each viewpoint into a data for display by performing several processing such as decoding process, and outputs it to the parallax adjusting unit 206.

The parallax adjusting region specifying unit 205 is a specifying (pointing) member which receives an operation by the user to specify (or point out) the region to which the parallax adjustment is done. The parallax adjusting region specifying unit 205 outputs, to the parallax adjusting unit 206, a signal specifying the region to which the parallax adjustment is applied which is indicated by the user's operation. The parallax adjusting region specifying unit 205 may be implemented by a touch panel, up/down/right/left directional keys, or the like.

The parallax adjusting unit 206 performs the parallax adjustment on the region specified by the user in the image of each viewpoint obtained from the image reproduction unit 204, based on the information from the region-parallax extraction unit 203 and the signal from the parallax adjusting region specifying unit 205. The parallax adjusting unit 205 outputs the image subject to the parallax adjustment to the image display unit 206. The parallax adjusting unit 206 may be adapted not to perform the parallax adjustment when it does not obtain the signal from the parallax adjusting region specifying unit 205.

The image display unit 207 displays the first and the second viewpoint images obtained from the parallax adjusting unit 206 as a stereoscopic image.

In the above described image file reproduction device 20, the file analyzer 202, the parallax adjusting determination unit 203, the image reproduction unit 204, and the parallax adjusting unit 205 may be implemented as software for a microcomputer or a DSP.

Meanwhile, when the parallax adjusting unit 206 outputs the image subject to the parallax adjustment to the image display unit 207, it may display the information indicating that it has performed the parallax adjustment together with the image. On the other hand, when the image does not satisfy the parallax condition even after the parallax adjustment, the parallax adjusting unit 206 may display the information indicating warning to the image display unit 207.

Further, when the header part 502 of the image file contains the information indicating that the main subject is contained in the sub-region (see FIG. 7A, FIG. 7B), the parallax adjusting unit 206 may identify the sub-region to perform the parallax adjustment based on the position of the main subject region and may perform the parallax adjustment on the identified sub-region.

Also, when the header part 502 of the image file contains the information on the stereo base as the shooting parameters, the parallax adjusting unit 206 may calculate the distance to the subject for each sub-region by using the stereo base information and the parallax information for each sub-region. By referencing the information calculated in the above described manner, various types of image processing according to the distance to the subject can be performed on reproducing the image.

### 3. Summarization

### 3. 1 Image File Generation Device

The image file generation device 10 of the present embodiment includes: the first and the second viewpoint image obtaining units 101, 102 which obtain data of a stereoscopic image enabling stereovision; the parallax analyzer 104 which obtains the parallax information for each of a plurality of sub-regions into which an entire region of the stereoscopic image is divided; and the file generator 107 which generates an image file including the data parts 503 and 507 which store the data of the stereoscopic image obtained by the first and the second viewpoint image obtaining units 101 and 102 and the header parts 502 and 506 which store the management data related to the data of the stereoscopic image stored in the data parts. The file generator 107 records parallax information (603) for each sub-region and information (601) on a method of division into the sub-regions, in the header part 502 of the image file.

With the image file generated by the image file generation device 10 in the above described manner, the image file reproduction device can obtain the parallax information for each of the sub-regions of the image, therefore, can perform the parallax adjustment on part of the region of the image.

Further, the file generator 107 places the information 601 on the dividing method at a position in the header part 502 of the image file, at which the information 601 can be read earlier than the parallax information 603. As a result, since the information 601 on the dividing method can be read out prior to the parallax information 603, the image file reproduction device can rapidly start the processing based on the information 601 on the dividing method.

Further, the header part 502 may include information indicating the image (the first viewpoint image or the second viewpoint image) which is used as a base for obtaining the parallax information. With that configuration, when an image file is reproduced in the reproduction device, the image which is used as a base for obtaining the parallax information stored in the header part 502 can be easily identified only by reading such information.

Further, the parallax analyzer 104 may obtain information on the maximum value of the amount of parallax in the first direction which is directed from the display screen toward a viewer (the direction of projection) and information on the maximum value of the amount of parallax in the second direction which is opposite to the first direction (the direction of recess) for each sub-region. With that configuration, when an image file is reproduced in the reproduction device, the easiness/difficulty of stereovision can be easily determined for each sub-region only by analyzing the header part 502 of the image file.

Further, the file generator 107 may store, in the header part 502, the information indicating the number of pieces of the parallax information contained in one sub-region. With that configuration, when an image file is reproduced in the reproduction device, the number of pieces of the parallax information recorded can be easily determined for each sub-region only by analyzing the header part 502 of the image file.

Further, the file generator 107 may store the information on the number of bits of the parallax information obtained for each sub-region in the header part 502 of the image file. With that configuration, when an image file is reproduced in the reproduction device, the bit precision of the recorded parallax information can be determined only by analyzing the header part 502 of the image file.

Further, the parallax analyzer 104 may obtain the information on the representative amount of parallax which represents the amounts of parallax in the sub-region, and the file generator 107 may store the information on the representative amount of parallax for each sub-region in the header part 502 of the image file. With that configuration, it is enough to store only the information on the representative amount of parallax, in the header part 502, so that the amount of information stored in the header part 502 can be reduced.

Further, the parallax analyzer 104 may obtain the information on the amount of parallax in the infinite direction in the stereoscopic image as the parallax information. The file generator 107 may store the information on the amount of parallax in the infinite direction obtained for the entire stereoscopic image, in addition to the information on the representative amount of parallax for each sub-region in the header part 502. With that configuration, it is enough to store only just one piece of infinite direction parallax information, in the header part 502 for the entire image. Thus the amount of information stored in the header part 502 can be reduced smaller than the case where, for example, the maximum amount of parallax for displaying the subject appearing in front of the screen display and the maximum amount of parallax for displaying the subject appearing behind the screen display are stored for each sub-region.

Further, the parallax analyzer 104 may obtain the parallax information including the representative amount of parallax which represents the amounts of parallax in the sub-region and information indicating the distribution of the amounts of parallax in the sub-region, for each sub-region. With that configuration, the amount of information stored in the header part 502 can be reduced. In addition, when an image file is reproduced in the reproduction device, a processing such as parallax adjustment can be performed based on the distribution of the amounts of parallax in the sub-region.

Further, the parallax analyzer 104 may output the parallax information including the information indicating that the parallax information cannot be detected, for a sub-region from which the parallax information cannot be obtained. Accordingly, when an image file is reproduced in the reproduction device, it can be easily determined that the parallax information has not been obtained in a particular sub-region by referring to the information indicating that the parallax information cannot be detected.

Further, the parallax analyzer 104 may calculate the reliability of the obtained parallax information for each sub-region, and the file generator 107 may further store the information indicating the reliability for each sub-region in the header part 502. With that configuration, when an image file is reproduced in the reproduction device, processing (for example, obtaining of the parallax information again) can be preferably changed for each sub-region according to the reliability corresponding to the parallax information.

Further, the file generator 107 may switch between storing of the parallax information obtained by the parallax analyzer 104 in the header part 502 and storing of information indicating that the parallax information cannot be detected, in place of the obtained parallax information, in the header part 502 based on the reliability. With that configuration, when the parallax information is stored in the header part 502 in the image file, the parallax information to be stored can be changed for each sub-region according to the reliability corresponding to the particular parallax information.

Further, the parallax analyzer 104 may determine whether the sub-region contains the main subject or not. The file generator 107 may store the information indicating the determination result made by the parallax analyzer 104 in the header part 502. With that configuration, when the image reproduction is performed on an image file by the reproduction device, it is possible to determine whether the main subject is in a predetermined region or not only by analyzing the header part 502 of the image file, therefore, for example, necessity of the parallax adjustment can be easily determined.

Further, the parallax information contained in the header part 502 may be information subject to compression processing. With that configuration, the amount of data in the header part can be reduced.

Further, the stereo base information indicating a distance between the two optical systems may be stored further in the header part 502. The image file reproduction device can calculate the distance to the subject for each sub-region based on the stereo base information and the parallax information read out from the header part 502.

### 3. 2 Image File Reproduction Device

The image file reproduction device 20 of the present embodiment is an image reproduction device which can reproduce stereoscopic image data enabling stereovision includes the file reading unit 201 which reads out an image file from the memory card 109 that stores an image file including stereoscopic image data enabling stereovision; the file analyzer 202 which analyses the image file; and the storage unit 203 which stores the parallax information. The parallax information defines a depth of an object in a direction perpendicular to a display screen on which a stereoscopic image is displayed.

The image file includes the data parts 503 and 507 which store stereoscopic image data and the header parts 502 and 506 which store the management data related to the stereoscopic image data stored in the data parts. The header part 502 of the image file stores the parallax information 603 for each of a plurality of sub-regions into which the entire region of the stereoscopic image is divided and information 601 on a method of dividing the region. The file analyzer 202 reads the information 601 on the dividing method and the parallax information 603 for each sub-region from the header part 502, and stores the read out parallax information in a storage area of the storage unit which is secured based on the read information on the dividing method.

With the above described configuration, the parallax adjustment on each of partial regions of the image can be performed by using the parallax information for each sub-region. Further, the region for storing the parallax information can be secured based on the information on the dividing method (for example, the number of sub-regions), and thus the overflow which would occur on the occasion of reading out the parallax information can be avoided.

Further, the header part 502 may further contain the information on the number of pieces of the parallax information contained in one sub-region. The file analyzer 202 reads out the information on the dividing method and the information on the number of pieces of the parallax information from the header part 502, and stores the read parallax information in the secured storage area of the storage unit based on these pieces of obtained information. With that configuration, the information necessary for determining the capacity required to store the information on the parallax can be obtained from the header part 502.

Further, the image file reproduction device 20 may further include the parallax adjusting unit 206 which performs the parallax adjustment for each sub-region based on the parallax information. With that configuration, the parallax adjustment on each of partial regions of the image can be performed.

The header part 502 may store either one of the parallax information in the sub-region and the information indicating that the parallax information cannot be detected in the sub-region, for each sub-region. The parallax adjusting unit 206 may not perform the parallax adjustment on the sub-region that has the information indicating that the parallax information cannot be detected. With that configuration, the image file reproduction device 20 can identify the region in which the parallax information has not been detected only by analyzing the header part 502 of the image file. Therefore, the image file reproduction device 20 can analyze the parallax information only for the region in which the parallax information has not been detected or perform the parallax analysis only on the region in which the parallax information has not been detected.

The header part 502 may further store the information indicating reliability of the parallax information for the sub-region. The parallax adjusting unit 206 may switch whether to perform the parallax adjustment on the sub-region or not based on the information indicating the reliability. With that configuration, the image file reproduction device 20 can identify high/low of the reliability of the parallax information only by analyzing the header part 502, therefore, it can analyze the parallax information by a high precision method of analyzing the parallax only for the region of low reliability or it can perform the parallax adjustment only on the region of high reliability.

The header part 502 may further store the subject information indicating whether the main subject is in the sub-region or not. In that case, the parallax adjusting unit 206 may switch whether to perform the parallax adjustment on the sub-region or not based on the subject information. With that configuration, the parallax adjustment can be performed based on the parallax information of the region containing the main subject only by analyzing the header part.

The header part 502 may further store the stereo base information indicating the distance between the two optical systems. The parallax adjusting unit 206 may determine the distance to the subject in the sub-region based on the stereo base information and the parallax information. With that configuration, the image file reproduction device can determine the distance to the subject for each sub-region.

### INDUSTRIAL APPLICABILITY

The present disclosure can be applied to a generation device of stereoscopic image data capable of generating a stereoscopic image such as a digital camera or a digital movie, or a reproduction device of stereoscopic image data such as a digital television, a digital video player/digital video recorder.

1. An image file generation device comprising:
an image obtaining unit configured to obtain data of a stereoscopic image enabling stereovision;
an parallax information obtaining unit configured to obtain parallax information for each of a plurality of sub-regions which are obtained by dividing an entire region of the stereoscopic image into the sub-regions; and
a file generator configured to generate an image file including a data part which stores data of the stereoscopic image obtained by the image obtaining unit and a header part which stores management data related to the data of the stereoscopic image stored in the data part, wherein
the file generator records, in the header part, parallax information for each sub-region, and information on a method of dividing the region for each sub-region.

2. The image file generation device according to claim 1, wherein the file generator places the information on the dividing method at a position in the header part, so that the information on the dividing method can be read out earlier than the parallax information.

3. The image file generation device according to claim 1, wherein the stereoscopic image includes a plurality of images which are captured at different viewpoints, and
the file generator stores, in the header part, information indicating an image which is used as a base for obtaining the parallax information among the plurality of images.

4. The image file generation device according to claim 1, wherein the parallax information obtaining unit obtains information on the maximum value of an amount of parallax in a first direction which is directed from the display screen toward a viewer and information on the maximum value of an amount of parallax in a second direction which is opposite to the first direction for each sub-region.

5. The image file generation device according to claim 1, wherein the file generator stores information indicating the number of pieces of the parallax information contained in a sub-region, in the header part.

6. The image file generation device according to claim 1, wherein the file generator stores information indicating the number of bits of the parallax information obtained for each sub-region, in the header part.

7. The image file generation device according to claim 1, wherein
the parallax information obtaining unit obtains information on a representative amount of parallax which represents amounts of parallax in each sub-region, as the parallax information, and
the file generator stores information on the representative amount of parallax for each sub-region, in the header part.

8. The image file generation device according to claim 7, wherein
the parallax information obtaining unit further obtains information on an amount of parallax in an infinite direction in the stereoscopic image, as the parallax information, and
the file generator stores, in the header part, the obtained information on the amount of parallax in the infinite direction for the entire stereoscopic image, in addition to the information on the representative amount of parallax for each sub-region.

9. The image file generation device according to claim 1, wherein the parallax information obtaining unit obtains the parallax information including a representative amount of parallax which represents the amounts of parallax in the sub-region and information indicating distribution of the amounts of parallax in the sub-region for each sub-region.

10. The image file generation device according to claim 1, wherein the parallax information obtaining unit outputs the parallax information including information indicating that the parallax information cannot be detected, for a sub-region from which the parallax information cannot be obtained.

11. The image file generation device according to claim 1, further comprising:
a reliability calculation unit which calculates reliability of the parallax information obtained by the parallax information obtaining unit for each sub-region, wherein
the file generator further stores information indicating the reliability for each of sub-region, in the header part.

12. The image file generation device according to claim 11, wherein the file generator switches between, based on the reliability, storing of the parallax information obtained by the parallax information obtaining unit in the header part and storing of information indicating that the parallax information cannot be detected, in place of the obtained parallax information, in the header part.

13. The image file generation device according to claim 1, further comprising:
a determination unit configured to determine whether a main subject is in the sub-region or not, wherein the file generator stores information indicating a determination result made by the determination unit, in the header part.

14. The image file generation device according to claim 1, wherein the stereoscopic image is composed of two images which are captured by two optical systems placed at different viewpoints, and stereo base information indicating a distance between the two optical systems is further stored in the header part.

15. The image file generation device according to claim 1, wherein information indicating a type of the parallax information stored in the header part is further stored in the header part.

16. The image file generation device according to claim 1, wherein the parallax information which is subject to compression is stored in the header part.

17. An image file reproduction device which can reproduce stereoscopic image data enabling stereovision comprising:
a file reading unit configured to read out an image file from a recording medium for storing an image file including stereoscopic image data enabling stereovision;
an analyzer configured to analyze the image file; and
a storage unit which stores parallax information defining a depth of an object in a direction perpendicular to a display screen on which a stereoscopic image is displayed, wherein
the image file includes a data part which stores stereoscopic image data and a header part which stores management data for the stereoscopic image data stored in the data part,
the header part of the image file stores parallax information for each of a plurality of sub-regions which are obtained by dividing an entire region of the stereoscopic image into the sub-regions and information on a method of dividing the region into the sub-regions, and
the analyzer reads out the information on the dividing method and the parallax information for each sub-region from the header part, and stores the read parallax information in the storage area of the storage unit which is secured based on the read information on the dividing method.

18. The image file reproduction device according to claim 17, wherein the header part further contains information on the number of pieces of the parallax information contained in a sub-region, and
the analyzer reads the information on the dividing method and the information on the number of pieces of the parallax information from the header part, and stores the read parallax information in the storage area of the storage unit which is secured based on the read information on the dividing method and on the number of pieces of the parallax information.

19. The image file reproduction device according to claim 17, further comprising:
a parallax adjusting unit configured to perform parallax adjustment for each sub-region based on the parallax information.

20. The image file reproduction device according to claim 19, wherein
the header part stores either one of the parallax information in the sub-region and information indicating that the parallax information cannot be detected in the sub-region for each sub-region, and
the parallax adjusting unit does not perform parallax adjustment on the sub-region which has the information indicating that the parallax information cannot be detected.

21. The image file reproduction device according to claim 19, wherein the header part further stores information indicating reliability of the parallax information for the sub-region, and
the parallax adjusting unit switches whether to perform the parallax adjustment on the sub-region or not, based on the information indicating the reliability.

22. The image file reproduction device according to claim 19, wherein the header part further stores subject information indicating whether a main subject is in the sub-region, and
the parallax adjusting unit switches whether to perform the parallax adjustment on the sub-region or not based on the subject information.

23. The image file reproduction device according to claim 17, wherein
the stereoscopic image is composed of two images which are captured by two optical systems placed at different viewpoints,
the header part further stores stereo base information indicating a distance between the two optical systems, and
the parallax adjusting unit determines a distance to a subject in the sub-region based on the stereo base information and the parallax information.

24. A method of generating an image file comprising:
obtaining data of a stereoscopic image enabling stereovision;
obtaining parallax information, for each of a plurality of sub-regions which are obtained by dividing an entire region of the stereoscopic image into the sub-regions, the parallax information defining a depth of an object in a direction perpendicular to a display screen on which the stereoscopic image is displayed;
generating an image file including a data part which stores data of the obtained stereoscopic image and a header part which stores management data for the data of the stereoscopic image stored in the data part, wherein
the parallax information for each sub-region and information on a method of dividing the region are stored in the header part.
